(19) United States
(12) Patent Application Publication
(10) Pub. No.: US 2002/0138350 A1
(43) Pub. Date: Sep. 26, 2002

(54) System and method for placing orders at a restaurant

(76) Inventor: Jeffrey M. Cogen, Flemington, NJ (US)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 09/887,365

(22) Filed: Jun. 22, 2001

Related U.S. Application Data
(60) Provisional application No. 60/277,719, filed on Mar. 22, 2001.

(51) Int. Cl. G06F 17/60

(52) U.S. Cl. 705/15

(57) ABSTRACT

A system and method for transmitting stored user selections from a restaurant menu application on a handheld computer to a terminal at a drive-through lane or walk-up ordering area at a restaurant. Using the menu application on a handheld computer, a customer can record menu selections that he/she wishes to order during the next visit to a restaurant. These menu selections can then be saved as a file in the memory on the handheld computer. When the customer later arrives at the restaurant, he/she can select the file with the previously recorded menu selections and beam (transmit) it to a station adjacent to the drive-through lane, without having to get out of the car, or to a station at a walk-up ordering area. When received by the station, the order can then be automatically transmitted to a computer terminal or printer within the restaurant, where restaurant employees can fulfill the order.

### CROSS-REFERENCE TO RELATED APPLICATIONS

The present application is based upon and gains priority from U.S. Provisional Patent Application Serial No. 60/277,719, filed Mar. 22, 2001 by the inventor herein and entitled “System And Method For Placing Orders At A Restaurant,” the specification of which is incorporated herein by reference.

### FIELD OF THE INVENTION

This invention relates to a remote ordering system for a restaurant. Specifically, the present invention discloses a system and method for transmitting stored user selections from a restaurant menu application on a handheld computer to a terminal at a drive-through lane or other ordering area of a restaurant.

### BACKGROUND OF THE INVENTION

Drive-through lanes in many restaurants have added a very beneficial feature for both the consumer and the proprietor. The drive-through lane allows the proprietor to remain open longer, while the restaurant is being cleaned for the next day. The drive-through lane also allows more efficient handling of customers with a reduction in staff. The customer gets the benefit of staying in his or her vehicle while being serviced. This is especially important to young families and to those with mobility problems, such as the aged, infirm, or physically handicapped.

Drive-through lanes have been around for quite some time. However, in the typical drive-through lane, a customer places an order by speaking into a microphone and listens to the attendant on a speaker. The quality of these microphones and speakers is often poor, resulting in miscommunication and errors in the order. By the time the customer finds out about the error, he or she has already waited in line several minutes and must then wait several more minutes for a correct order to be filled. Or, all too often, the customer does not discover the error until he or she is home, in which case it is generally too late to correct the error. This results in the loss of customer goodwill.

A limitation of previous drive-through ordering systems that do not use a microphone is that they require the customer to lean out of the vehicle to press a button on a menu or use a touch screen. This is awkward, if not impossible, for some people. Also, this exposes the customer to rain, snow, etc. during the entire time that the order is being entered into the system. Furthermore, this process can be quite lengthy for very large orders, and can be intimidating or discouraging for people who do not feel comfortable interacting with a computer terminal or touch screen to place an order.

Attempts have been made to provide alternate remote ordering systems. For example, U.S. Pat. No. 5,969,968 to Pentel discloses a remote ordering system that enables customers to select items using a remote control device in response to displays on a terminal at a drive-through lane. Unfortunately, however, the Pentel device fails to address significant shortcomings in the prior art devices. For example, Pentel provides no convenient and reliable way to store and communicate a pre-selected list of selections from the restaurant menu. The device of Pentel merely allows a user to sequentially enter specific item identification numbers and item quantities through a remote keypad instead of through verbal communication. While customers often write down a list of items on a piece of paper prior to going to the drive through lane, they still have to read the list when it is time to place the order. Thus, even when using a device as in Pentel, users remain at risk of entering the order incorrectly.

Other attempts have been made to provide remote ordering systems that enable a user to maintain order lists for later use. For example, U.S. Pat. No. 5,664,110 to Green et al. discloses a remote ordering system implemented through an individual display/processor unit which receives and stores a user's order list. After a list has been compiled, the display/processor unit must then establish a telephonic or physical communications link with a data format/transfer computer which controls the flow of information between the display/processor unit and a merchant database. After such communication has been established, the user's order list is transferred to the merchant for order fulfillment through either future delivery to the customer or holding at the merchant's location for later pickup by the customer. However, Green does not provide any means by which a user may carry with them to the merchant's own location a computerized listing of products available from the merchant, or any means by which the user could transmit an order directly to the merchant while at the merchant's location, as would occur in the case of a consumer at a restaurant.

Moreover, none of the prior art devices provide any means by which a user might store a menu or other product listing application on a transportable computer to enable a user to ensure both accurate order input, by recording menu selections as they are given at a place other than the merchant's location, and accurate order transmission, by enabling real-time on location communication between an order storage/input device and an order receiving computer at the merchant's location.

Though this discussion is focused mainly on ordering at drive-through lanes, many of the same shortcomings are present when ordering inside at a restaurant. There is a large opportunity for forgetting to order a desired item or to have a miscommunication when verbally placing an order. Furthermore, placing orders verbally is not efficient.

If there was a convenient and reliable way to store and communicate a pre-selected list of selections comprising the restaurant order it would increase efficiency for the restaurants, since some customers would have their selections made prior to arrival at the drive-through or indoor ordering area, and it would be easier for customers, who could store their previous orders for future re-use or modification, and who could record their selections in the comfort of their homes or offices, rather than in the stressful location of the restaurant ordering area. This would be particularly useful for large families or people who frequently place orders for a large number of co-workers or friends.

Handheld computers typically weigh less than 2 pounds and fit in a pocket. They generally provide some combination of personal information management, database functions, word processing and spreadsheets, Internet browser, email, portable telephone, digital music player, etc. Handheld computers are usually equipped with means for transmitting application files and other data to other computers or other handheld computers. Despite their ability to store and transmit files, data, and applications, prior art handheld computers do not include applications for storing and transmitting substantially complete restaurant menus or restaurant menu selections to a drive-through or indoor ordering station at a restaurant.

### SUMMARY OF THE INVENTION

It is therefore an object of the present invention to provide a solution to the problem of storing substantially entire menus and menu selections on a remote ordering device. It is a further object of the present invention to provide a solution to the need for a convenient and efficient way to place an order at a drive-through or walk-up ordering station at a restaurant.

According to the present invention, a customer can load a menu application (computer program) onto a handheld computer. Using the menu program on the handheld computer the customer can record selections (menu selections) that he/she wishes to order during his/her next visit to a restaurant. These menu selections can then be saved as a file in the memory on the handheld computer. When the customer later arrives at the restaurant, he/she can select the file with the previously recorded menu selections and beam (transmit) it to a station adjacent to the drive-through lane, without having to get out of the car, or to a station at a walk-up ordering area.

When received by the drive-through or walk-up station, the order can then be automatically transmitted to a computer terminal or printer within the restaurant, where restaurant employees can fulfill the order.

Other objects, features and advantages of the present invention will be apparent from the accompanying drawings, and from the detailed description.

### BRIEF DESCRIPTION OF THE DRAWINGS

The objects, features, and advantages of the present invention will be apparent from the following detailed description of the invention with references to the following drawings.

FIG. 1 is a schematic representation of the remote ordering system for a restaurant drive-through lane of the present invention.

FIG. 2 is a schematic representation of the remote ordering system for a restaurant walk-up station of the present invention.

FIG. 3 is a schematic representation of the method of the present invention for remote ordering at a restaurant drive-through lane.

FIG. 4 is a schematic representation of the method of the present invention for remote ordering at a restaurant walk-up station.

FIG. 5 is a schematic representation showing one embodiment of the menu application (program).

FIG. 6 is a schematic representation showing a second embodiment of the menu application (program).

FIG. 7 is schematic representation of the main screen of a handheld computer comprising a restaurant menu application.

FIG. 8 is a schematic representation of a screen from the restaurant menu application according to one embodiment in which menus for several different restaurants are accessible within the menu application.

FIG. 9 is a schematic representation of an individual restaurant menu screen from a restaurant menu application on a handheld computer.

FIG. 10 is a schematic representation of a screen from a restaurant menu application showing the user's list of current selections from a restaurant menu in a restaurant menu application on a handheld computer.

FIG. 11 is a schematic representation of a screen from a restaurant menu application showing an individual selection from a restaurant menu in a restaurant menu application on a handheld computer.

FIG. 12 is a flow chart showing the general steps carried out by a user while using a restaurant menu application on a handheld computer to make selections and save them in a file.

FIG. 13 is a flow chart showing the general steps carried out by a user to open, modify, and save a previously saved file of selections using a restaurant menu application on a handheld computer.

FIG. 14 is a schematic representation of a terminal in restaurant used by restaurant employees to fulfill orders.

FIG. 15 is a schematic representation of a single order display from a terminal in restaurant.

FIG. 16 is a flow chart depicting steps of a customer interaction with the drive-through station while beaming an order according to one embodiment of the invention.

FIG. 17 is a flow chart depicting steps of a customer interaction with the walk-up station while beaming an order according to one embodiment of the invention.

### DETAILED DESCRIPTION

The present invention discloses a system and method for remote ordering at a drive-through lane or walk-up ordering area at a restaurant. In the following description, for purposes of explanation, specific nomenclature is set forth to provide a thorough understanding of the present invention. However, it will be apparent to one skilled in the art that these specific details are not required to practice the present invention. Furthermore, the present invention is described using some of the possible embodiments. For example, the present invention is described with reference to a handheld computer. However, any personal digital assistant or electronic device can be used, provided that it can store a menu application in resident memory, can transmit menu selections to a terminal at a drive-through lane or walk-up ordering area at a restaurant using infrared or other radiation, and can be easily carried in one hand or in a pocket. Thus, the teachings of the present invention can be applied to a cellular phone, a personal digital assistant, an electronic organizer, or other electronic devices that can be readily transported from a home or office to a restaurant in a car or a pocket for use at a drive-through lane or walk-up ordering area at the restaurant. Examples of commercially available handheld computers useful in the present invention include the Kyocera pdQ 800 Smartphone and Kyocera pdQ 1900 Smartphone; Casio Cassiopeia E-125 and Casio Cassiopeia EM-500; Compaq Aero 1550 Pocket PC and Compaq iPAQ H3650 Pocket PC; Handspring Visor Platinum and Handspring Visor Prism; Hewlett Packard Jomada 548 and Hewlett Packard Jornada 720; Palm m100, Palm IIIc, Palm IIxe, Palm Vx, Palm VIIx, Palm m500 and Palm m505; S3 Diamond Mako; Sony Clie Handheld PEG-S300; and the TRGpro. All of these commercially available handheld computers comprise infrared data ports for transferring information from the handheld computer to another device. Other suitable handheld computers are currently available, and it is understood that new developments will lead to other personal electronic devices that satisfy the above-mentioned requirements of the handheld computer of this invention.

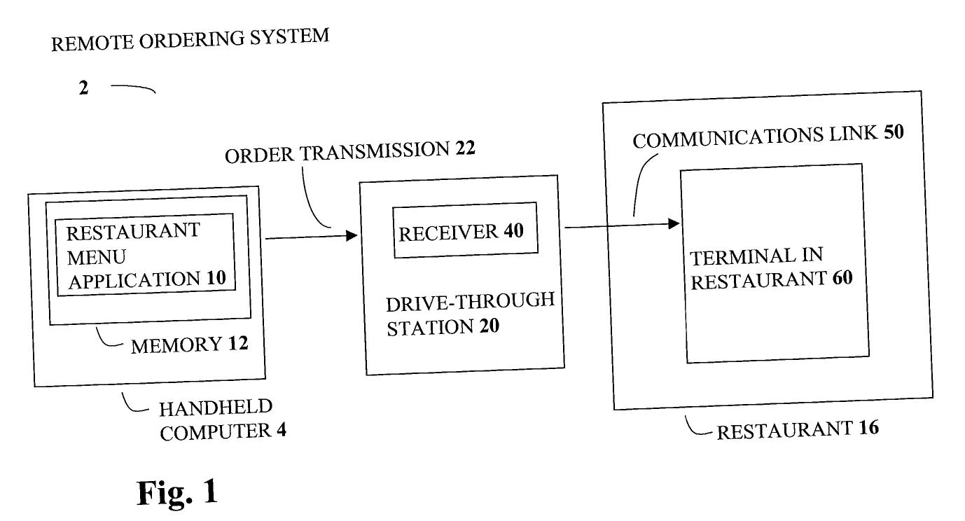

FIG. 1 shows one embodiment of the remote ordering system 2. A handheld computer 4 comprises a restaurant menu application 10 resident in memory 12. The menu application 10 comprises substantially the entire menu (e.g., all “regular” menu items that are not considered “specials” or available for a limited time) for at least one restaurant. The handheld computer 4 further comprises input means, such as a keyboard, pressure sensitive pad, stylus sensitive pad, touch screen, or microphone with voice recognition software. Using the input means, the user can record selections from a menu in menu application 10 and save them in a file in memory 12 on handheld computer 4. At any later time, the user can open stored files and edit them if the user wishes to make changes. When the user wishes to place an order at a restaurant using a drive-through lane, the user transports the handheld computer with him/her in an automobile, stops the automobile adjacent to drive-through station 20, and transmits (beams) a saved file comprising menu selections via order transmission 22. Receiver 40 on drive-through station 20 then receives the order transmission 22, comprising the menu selections. The menu selections are then transmitted, via communications link 50, to a terminal in restaurant 60, where the menu selections can be printed or displayed for restaurant employees, who can fulfill the order. It is understood that drive-through station 20 and/or terminal in restaurant 60 may comprise microprocessors and/or software to facilitate order transmission 22 and communications link 50, as are known and used in restaurants for transmitting orders taken by a restaurant employee using a computerized cash register/order entry device. Such microprocessors and/or software particularly provide for the processing or formatting of data input by the restaurant employee into a form that may be printed or displayed for other restaurant employees charged with fulfillment of the order.

With respect to order transmission 22, in the preferred embodiment it comprises an infrared link based on Infrared Data Association (IRDA) compliant methodology. However, in other embodiments it can instead comprise radio or other frequencies, the key feature being that direct electrical contact is not required between handheld computer 4 and receiver 40.

Technology to achieve infrared transmission of data from a handheld computer to another computer, device, or network is well known to those skilled in the art, and is widely used in a variety of infrared-equipped devices, such as desktop computers, portable computers, handheld computers, digital cameras, personal communications services (PCS) handsets, and the like. Such technology is disclosed, for example, in U.S. Pat. Nos. 5,075,792, 5,506,445, 5,617,236, 5,668,383, 5,922,037, 5,940,199, 5,953,507, 5,982,520, 6,029,213, 6,064,299, 6,088,730, 6,128,117, and 6,169,295, all of which are incorporated herein by reference. Also, see IRDA Data Link Design Guide, pp. 1-28, Hewlett Packard. The Infrared Data Association (IrDA), a non-profit international standards organization that was founded in 1993, develops and promotes hardware and software protocol standards for the infrared communications links in computing, communications, and electronics consumer devices.

IrDA's infrared standards are now accepted by computer and telecommunications hardware and software manufacturers worldwide. The IRDA serial infrared (SIR) physical layer link specification Versions 1.0, 1.1 and 1.2 are provided to facilitate the point-to-point communication between infrared interface port-equipped electronic devices (e.g., computers and peripheral devices) using directed half duplex serial infrared communications links through free space. The documents specify the optical media interface, and 0.576 Mbps, 1.152 Mbps and 4.0 Mbps modulation and demodulation. They contain specifications for the Active Output Interface and the Active Input Interface, and for the overall link.

The IrDA specifications provide guidelines for link access, link management and for the physical transfer of data bits. The link access mechanism provides guidelines for the software, which looks for other machines to connect or to sniff, to discover other machines, to resolve addressing conflicts, and to initiate a connection, to transfer data, and to cleanly disconnect. The link access standard specifies a frame and byte structure of the infrared packets as well as the error detection methodology for the infrared communication. The IrDA specifications for operating distance, viewing angle, optical power, data read, and noise immunity enable physical interconnectivity between various brands and type of equipment, such as a handheld computer and another computer.

Radio frequency links are also well known in the art and may be used in one embodiment of the invention for transmitting (beaming) the orders from the handheld computer to the drive-through station. For example, the Bluetooth Specification (www.bluetooth.com) defines wireless technology standards and specifications for small-form factor, low-cost, short-range radio links between mobile PCs, mobile phones and other portable devices. The Bluetooth Special Interest Group is an industry group consisting of leaders in the telecommunications, computing, and networking industries that are driving development of the technology and bringing it to market. Version 1.0 of the Bluetooth specification was published 1999 and is available at www.bluetooth.com.

In the preferred embodiment receiver 40 is an IrDA compliant infrared transceiver.

With respect to communications link 50, in the preferred embodiment it comprises a direct electrical connection. However, in other embodiments it can be a radio frequency or other type of transmission, provided that it is not at a frequency that interferes with order transmission 22.

In the preferred embodiment, drive-through station 20 is physically separated from terminal in restaurant 60 by at least about three feet to as much as about 300 feet. However, it is understood that in other embodiments the drive-through station 20 may not be physically separated from terminal in restaurant 60 as, for example, if they are both contained in a single console, the drive-through station 20 being exposed to the outside of a building with the terminal in restaurant 60 being exposed to the inside of the building.

In the preferred mode, the drive-through station 20 will be placed in a drive-through area of the restaurant, but it may also be placed somewhere else in the vicinity of the restaurant. Thus the user can drive up to or walk over to the drive-through station 20.

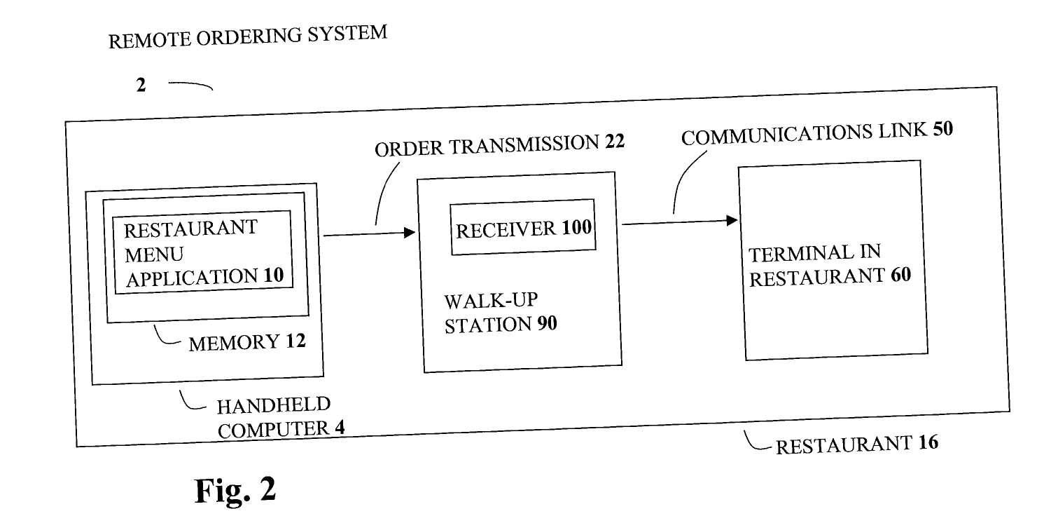

FIG. 2 illustrates another embodiment of the remote ordering system. In this embodiment, handheld computer 4, restaurant menu application 10, memory 12, and order transmission 22 are as described in the previous embodiment described in FIG. 1. In this embodiment, however, the user places an order inside a restaurant 16 using a walk-up station 90. The user transports his/her handheld computer 4 with him/her to restaurant 16, walks to the walk-up station 90, and transmits (beams) a saved file comprising menu selections via order transmission 22. Receiver 100 on walk-up station 90 then receives the order transmission 22, comprising the menu selections. The menu selections are then transmitted, via communications link 50, to a terminal in restaurant 60, where the menu selections can be printed or displayed for restaurant employees, who can fulfill the order. It is understood that walk-up station 90 and/or terminal in restaurant 60 may comprise microprocessors and/or software to facilitate order transmission 22 and communications link 50.

Order transmission 22 preferably comprises an IRDA compatible infrared link, although it can instead comprise other frequencies such as radio frequency (for example, Bluetooth), the key feature being that direct electrical contact is not required between handheld computer 4 and receiver 100.

In the preferred embodiment receiver 100 is an IRDA compliant infrared transceiver.

In the preferred embodiment, when an order is beamed from the handheld computer to the drive-through station or walk-up station, a file comprising the customer's selections is transmitted from the memory in the handheld computer to a microprocessor on the drive-through station or walk-up station, or to a microprocessor on the terminal in restaurant, via infrared transceivers on the handheld computer and drive-through station or walk-up station.

With respect to communications link 50, it preferably comprises a direct electrical connection. However, in less preferred embodiments it can be a radio frequency or other type of transmission, provided that it is not at a frequency that interferes with order transmission 22.

Walk-up station 90 can be located anywhere inside the restaurant. In one embodiment, it will be located within about 10 feet of a cash register so that the order can be beamed instead of verbally delivered to the worker at the cash register. In another embodiment walk-up station 90 will be in an express ordering lane of the restaurant, with or without a cash register nearby.

In another embodiment, walk-up station 90 will be located at a personal customer dining location within the restaurant, such as an individual table within restaurant 16.

Various layouts of the system will be readily apparent to those skilled in the art. For example, in one embodiment the drive-through station 20 or walk-up station 90 will comprise a computer, which is part of a local computer network at the restaurant 16. Orders beamed to the drive-through station or walk-up station via receivers 40 or 100 (for example, an IrDA or Bluetooth compliant transceiver) are then temporarily stored on the computer and can be accessed by or transferred to or displayed on other computers, display devices, or printers on the network, such as a computer that comprises the terminal in restaurant 60 or computers operated by the cashier or drive-through attendant. In a second embodiment, receivers 40 or 100 (for example, an IRDA or Bluetooth compliant transceiver) on the drive-through station and walk-up station may be wired directly to a computer within the restaurant which is accessible to the drive-through attendant, the cashier, and to the employees responsible for fulfilling the order, either directly or via a local computer network at the restaurant. In the preferred embodiments, the drive-through station and walk-up station will comprise a display device capable of displaying information originating from computers within the restaurant, which display device may optionally be connected to a computer network at the restaurant.

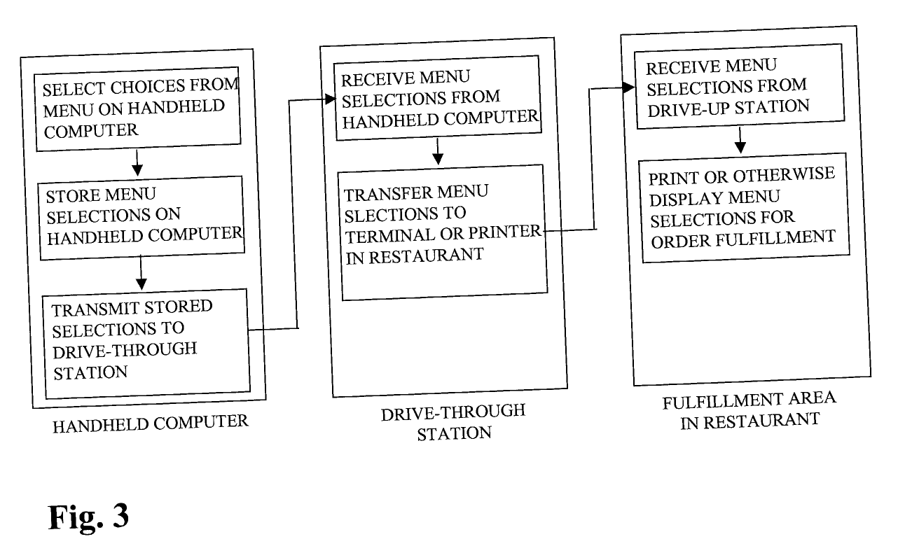

FIG. 3 illustrates one embodiment of the method of the present invention. Using the restaurant menu application 10 on a handheld computer 4, the user selects choices from a menu (menu selections) and stores the menu selections in a file on the handheld computer. When the user arrives at the drive-through station at the restaurant he/she transmits (beams) the file containing the stored menu selections from the handheld computer to the receiver on the drive-through station. The selections are then transferred from the drive-through station to the terminal in restaurant. The selections are then printed or otherwise displayed for restaurant employees who are responsible for fulfilling the order.

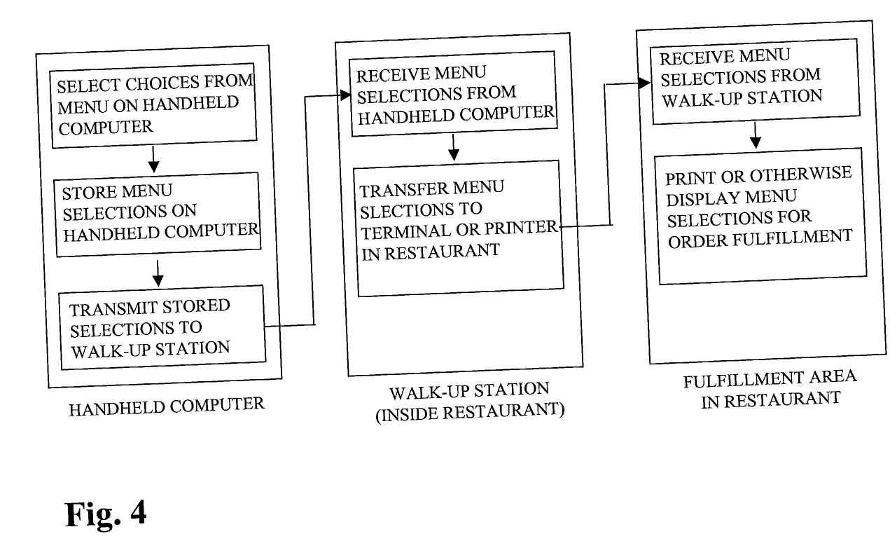

FIG. 4 illustrates another embodiment of the method of the present invention. Using the restaurant menu application 10 on a handheld computer 4, the user selects choices from a menu (menu selections) and stores the menu selections in a file on the handheld computer. When the user arrives at the walk-up station in the restaurant he/she transmits (beams) the file containing the stored menu selections from the handheld computer to the receiver on the walk-up station. The selections are then transferred from the walk-up station to the terminal in restaurant. The selections are then printed or otherwise displayed for restaurant employees who are responsible for fulfilling the order.

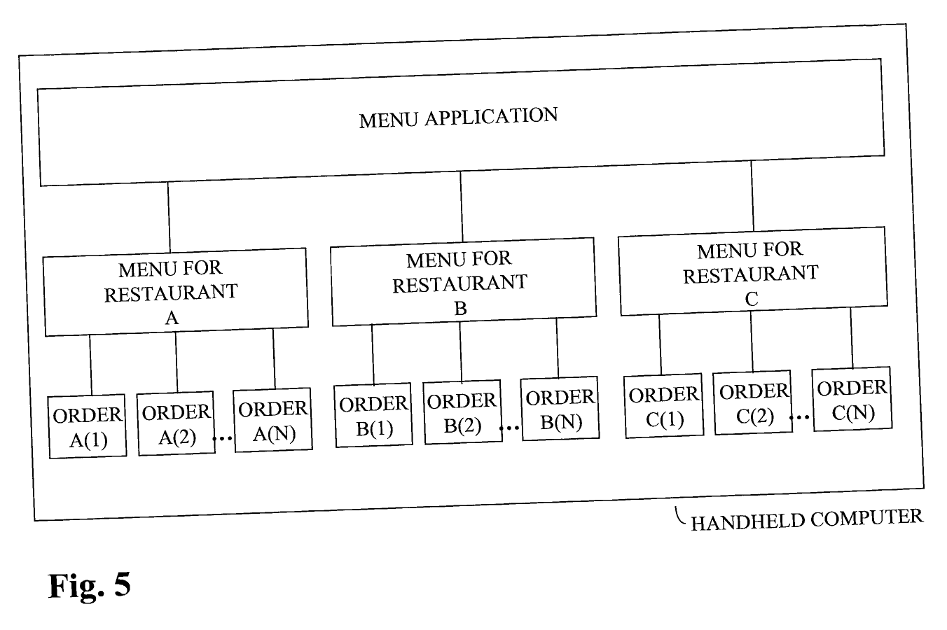

FIG. 5 illustrates one embodiment of the restaurant menu application (also referred to hereinafter as menu application or program). In this embodiment, the menu application can utilize menus from a plurality of restaurants and can store multiple menu selection files for each restaurant. The various menus and files are organized by unique names or numbers and stored in memory on the handheld computer. Referring again to FIG. 5, restaurants A, B, and C each have a different menu, each of which is stored on the handheld computer. Files containing menu selections are stored. For example, the file designated Order A(1) in FIG. 5 contains all of the user's menu selections from the menu of restaurant A. For example, it may contain all of the lunch selections for an entire family for a specific visit to the restaurant. The file designated Order A(2) contains a different complete set of menu selections from the menu of restaurant A. For example, it may contain all of the dinner selections for the same entire family for a specific visit to the restaurant. The N, such as in Order A(N), is a variable used to signify that any number of menu selection files can be saved for each menu, with each file comprising all of the selections for a particular order to be placed at a drive-through lane or walk-up ordering area of a restaurant. Although FIG. 5 shows a case where there are three menus on the handheld computer (for restaurants A, B, and C) it is understood that there is not a limit to the number of menus that can be stored according to present invention, any practical limit being due only to the amount of memory available on the handheld computer.

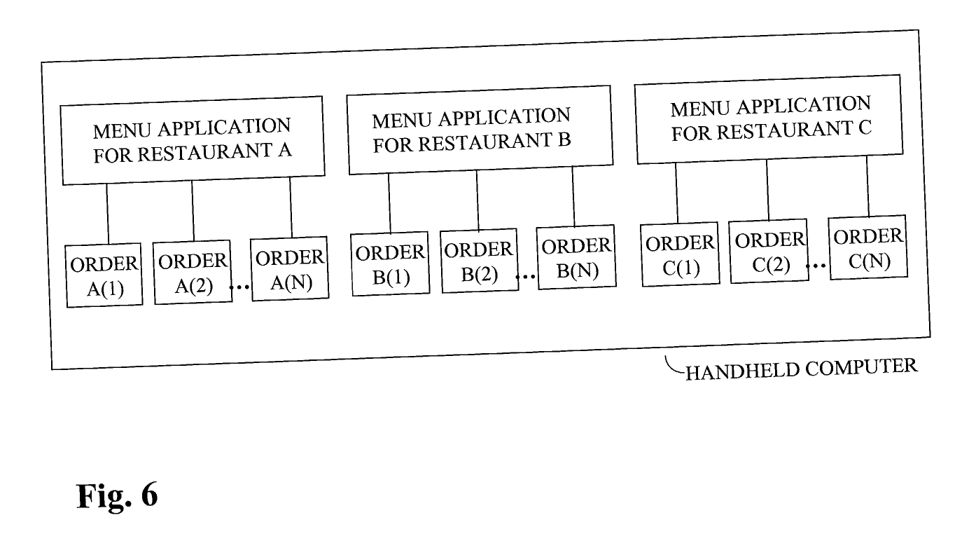

FIG. 6 illustrates another embodiment of the menu application. In this embodiment, each menu runs as an independent application on the handheld computer. The various menus and files are organized by unique names or numbers and stored in memory on the handheld computer. Referring again to FIG. 6, restaurants A, B, and C each have a different menu and menu application, each of which is stored on the handheld computer. Files containing orders (menu selections) are stored. For example, the file designated Order A(1) in FIG. 6 contains all of the user's selections from the menu of restaurant A. For example, it may contain all of the lunch selections for an entire family for a specific visit to the restaurant. The file designated Order A(2) contains a different complete set of menu selections from the menu of restaurant A. For example, it may contain all of the dinner selections for the same entire family for a specific visit to the restaurant. The N, such as in Order A(N), is a variable used to signify that any number of files can be saved for each menu, with each file comprising all of the menu selections for a particular order to be placed at a drive-through lane or walk-up ordering area of a restaurant. Although FIG. 6 shows a case where there are three menu applications on the handheld computer (for restaurants A, B, and C) it is understood that there is no limit to the number of menus and menu applications that can be stored according to present invention, any practical limit being due only to the amount of memory available on the handheld computer.

The restaurant menu application can be written using programming languages and techniques that are well know to those skilled in the art. For example, programming methods for the Palm OS and Windows CE operating system are well known to those skilled in the art.

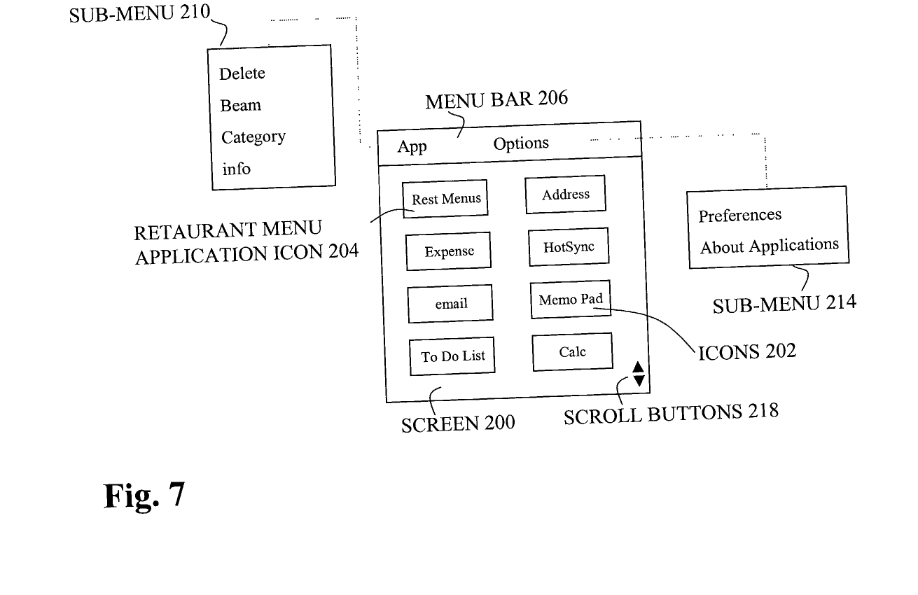

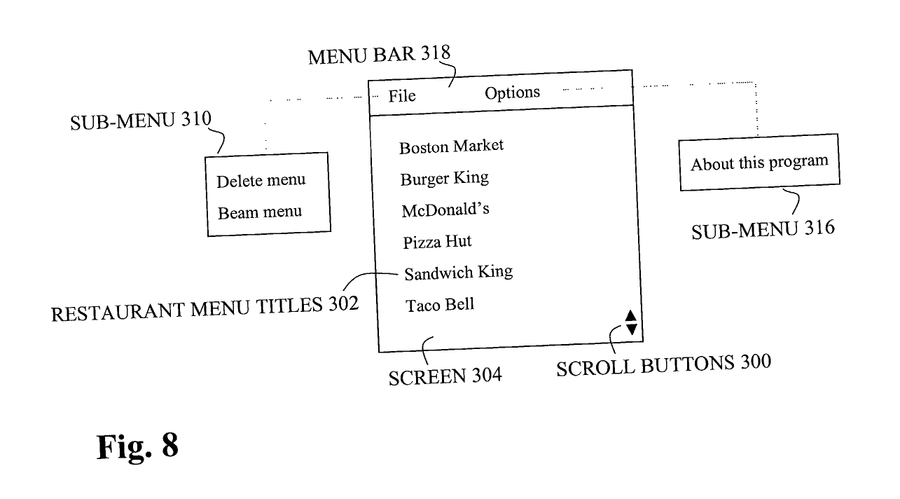

FIG. 7 shows a representation of the main screen 200 of the handheld computer in one embodiment of the menu application. Icons 202 are present for various applications contained on the handheld computer, including a restaurant menu application icon 204. The menu bar 206 enables the user to tap with a stylus to select a sub-menu 210 or 214, to make various commands, such as deleting, beaming, sorting applications into categories, obtaining on-screen information, selecting preferences, or displaying general information about the handheld computer. Scroll buttons 218 allow the user to use a stylus to scroll down to view icons that do not fit on the current screen view. When the user taps on the restaurant menu application icon 204, the user is presented with the view schematically represented in FIG. 8 showing all of the restaurant menus that are available in the restaurant menu application.

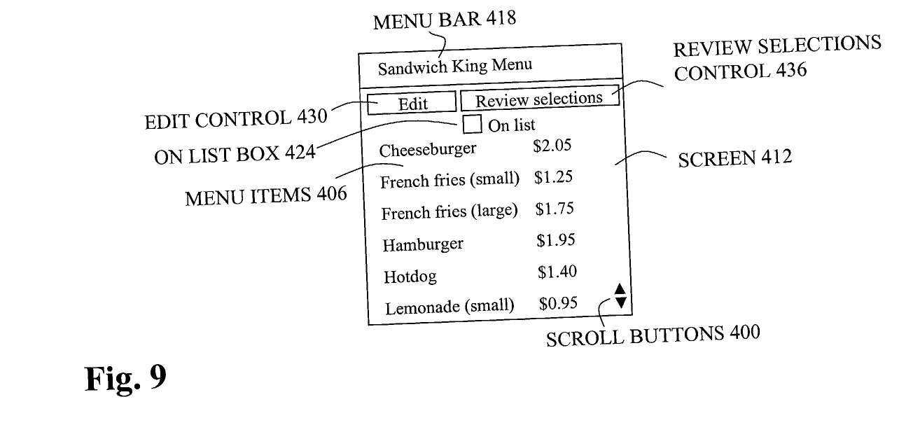

Referring to FIG. 8, scroll buttons 300 are used to display additional restaurant menu titles 302 that are off the visible screen 304. Various commands are available in sub-menus 310 and 316 via the menu bar 318 such as commands for deleting a menu from the menu application, beaming a menu to another device, or displaying general information about the restaurant menu application. When the user wishes to access a specific restaurant menu, the user can tap on one of the restaurant menu titles 302 with a stylus, which presents a new view illustrated in FIG. 9, comprising individual restaurant menu items for the selected restaurant.

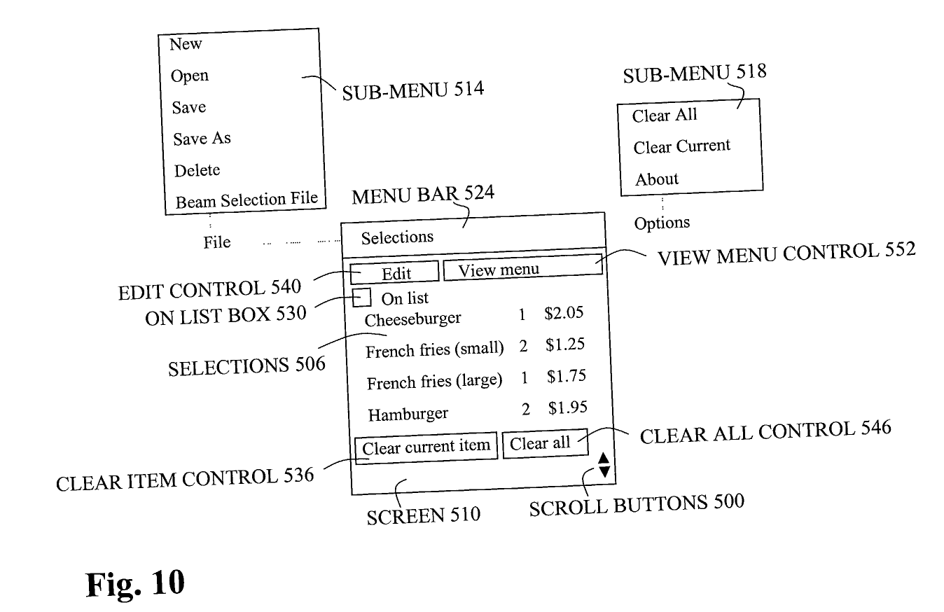

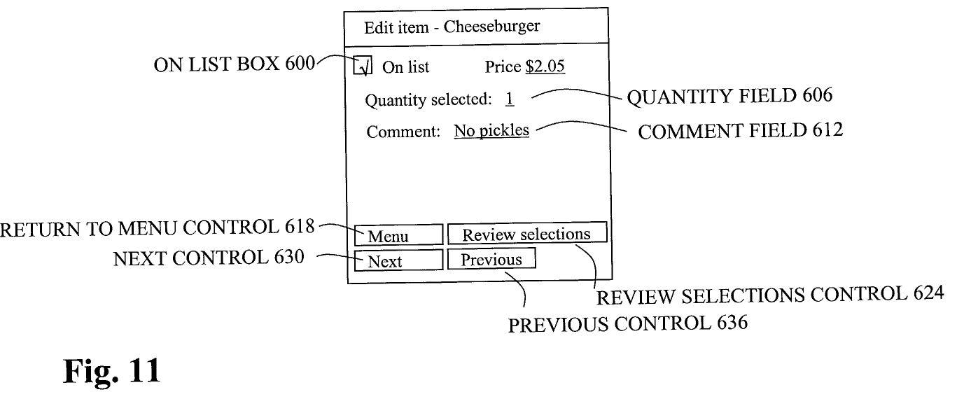

Referring to FIG. 9, scroll buttons 400 are used to display additional menu items 406 that are off the screen 412. Thus, while FIG. 9 particularly shows a listing of a plurality, and more particularly six, distinct menu items, this is for exemplary purposes only, and any number of menu items may be displayed by screen 412 at one time, with scroll buttons 400 enabling a user to display the fall listing of distinct menu items that comprise the particular restaurant menu. Various commands, available in sub-menus (not shown) can be accessed via the menu bar 418 using the stylus on the pressure sensitive screen 412. When the user wishes to select an item (add it to the list of selections comprising the order to be placed), the user can tap on one of the menu items 406 with a stylus to highlight that item. Once a menu item is highlighted, the user has several options available. For example, tapping the on list box 424 adds that menu item to the list of selections with a default quantity of 1. Once an item is already added to a list of selections, a check would be present inside the on list box 424 when that item was highlighted. Tapping again on the on list box 424 when a check is present would remove that item from the list of selections. Alternatively, clicking on the edit control 430 after highlighting a menu item will take the user to the view shown if FIG. 11 (discussed below). At any time, the user can tap on the review selections control 436 with the stylus to review the current list of selections, as illustrated in FIG. 10.

Referring to FIG. 10, scroll buttons 500 are used to display additional selections 506 that are off the screen 510. Various commands are available in sub-menus 514 and 518 via the menu bar 524 (i.e. by tapping on the pressure sensitive menu bar 524 with the stylus). Particularly noteworthy sub-menu commands are those that enable the user to save the selections as a file on the handheld computer (“Save” and “Save As”), to open previously saved files (“Open”), or to beam the selections (“Beam Selection File”). When the user wishes to edit a particular one of the selections 506, the user can tap on one of the selections with a stylus to highlight that item. Once a selection is highlighted, the user has several options available. For example, tapping the on list box 530 or clear item control 536 removes that that item from the selections 506; or tapping on the edit control 540 takes the user to a view illustrated in FIG. 11 (discussed below); or tapping on the clear all control 546 clears all selections 506; or tapping on the view menu control 552 takes the user back to a menu screen, such as that illustrated in FIG. 9. Note that on the view shown in FIG. 10 the currently selected quantities and the prices are displayed to the right of each selection.

FIG. 11 illustrates the view seen by the user when editing an individual selection. This view is accessed by highlighting an item then tapping on the edit control from the views in FIG. 9 or FIG. 10. Referring to FIG. 11, tapping the on list box 600 removes that item from the list of selections. Tapping on the quantity field 606 enables the user to enter a different quantity using a stylus. Tapping on the comment field 612 enables the user to enter a comment or special request for this item. In the present illustration, the user has entered a comment requesting “no pickles” on the cheeseburger. The user can tap on the return to menu control 618 to return to the menu view, such as that illustrated in FIG. 9. Tapping on the review selections control 624 will bring the user to a screen such as that shown in FIG. 10. Tapping on the next control 630 or previous control 636 will take the user to an edit item screen similar to that illustrated in FIG. 11 for the next or previous item on the selection list, respectively.

In the embodiments illustrated in FIGS. 7 through 11, a single restaurant menu application included menus from multiple restaurants. In other embodiments, wherein each restaurant has its own menu application, one or more icons to access individual restaurant menu applications will be present on the main screen of the handheld computer. Tapping on any such icons, using a stylus on the pressure sensitive screen, would access the appropriate restaurant menu application.

The restaurant menu application may also contain functionality to enable users to find out nutritional or other information about specific items on the restaurant menu to aid in the selection decision process.

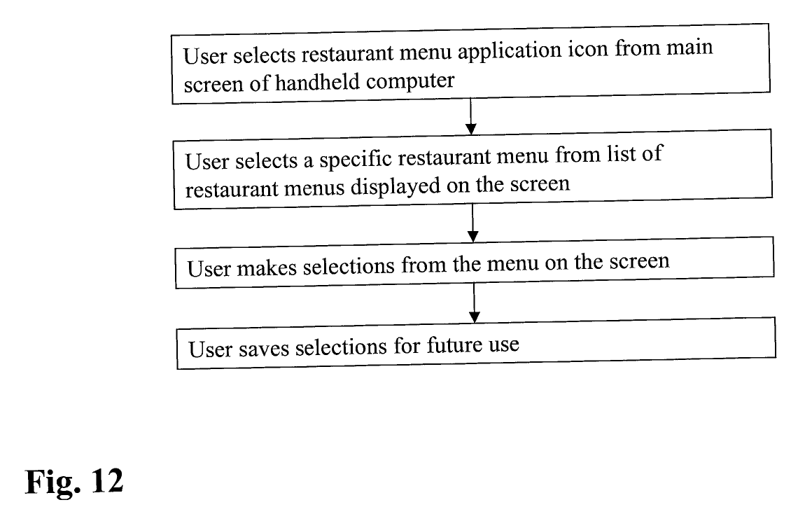

In one embodiment of the method of the present invention, as outlined in FIG. 12, the user selects the restaurant menu application icon from main screen of handheld computer; selects a specific restaurant menu from a list of restaurant menus displayed on the screen; makes selections from the menu on the screen; then saves selections for future use.

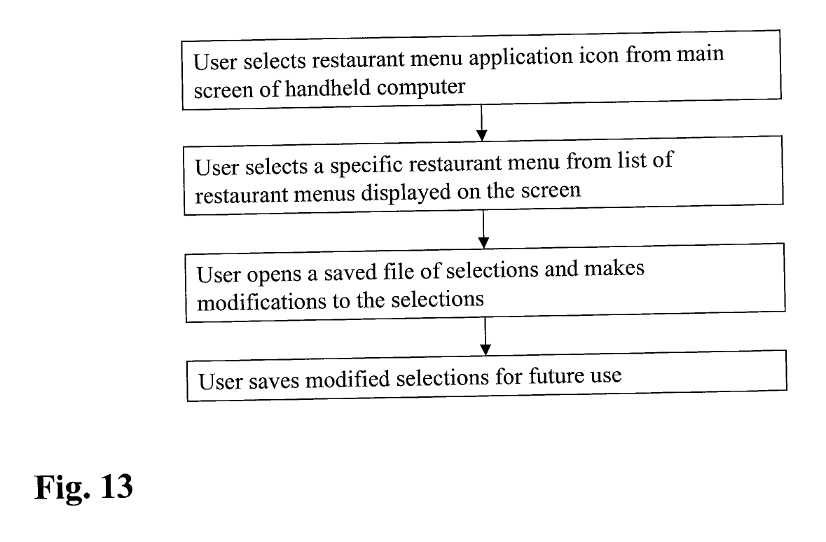

In another embodiment of the method of the present invention, as outlined in FIG. 13, the user selects the restaurant menu application icon from main screen of handheld computer; selects a specific restaurant menu from the list of restaurant menus displayed on the screen; opens a saved file of selections and makes modifications to the selections; then saves modified selections for future use.

A copy of the restaurant menu application may optionally reside on a desktop computer (PC), in addition to on the handheld computer. If it resides on a PC, menu selections can optionally be made on the PC and then downloaded to the restaurant menu application on the handheld computer prior to going to the restaurant and transmitting the order to the drive-through or walk-up station.

In one embodiment, a restaurant or agent of the restaurant will provide a computer program (restaurant menu application) comprising substantially the entire menu for the restaurant. In another embodiment, a restaurant may provide files comprising part of a program or database to work in conjunction with a restaurant menu application to enable the restaurant menu application user to use that particular restaurant's menu in addition to menus from other restaurants. These restaurant menu applications, computer programs, parts of a program, or database files can be installed on the handheld computer via several different installation means, including downloaded via the Internet, supplied via a diskette, a CD, a zip disk, cable connection, removable storage device, or other means. Or it can be transmitted (beamed) to the handheld computer from another handheld computer, computer port, the restaurant drive-through or walk-up station, or other means. Alternatively, it can come pre-installed on the handheld computer. The program could first be installed on a PC and then transferred to the handheld computer, or it could be directly installed on the handheld computer via installation means described above. The ability to add and remove menus from the handheld computer using a PC is advantageous, since users may wish to change which menus are on the handheld computer, for example, as their preferences change over time.

It is understood that at any give time the menu application might not be 100% up-to-date if the restaurant has changed its menu since the customer last updated his/her restaurant menu application. And certain items, such as “specials” may not be up to date or included at all in the restaurant menu application. It is understood that during the order transmission or communications link the restaurant my wish to display on the drive-through or walk-up terminal, or otherwise offer, selections that are not contained in the user's restaurant menu application. It is further understood that the restaurant may offer to transmit (beam) an updated version of the restaurant menu application to the user's handheld computer before or after the order transmission.

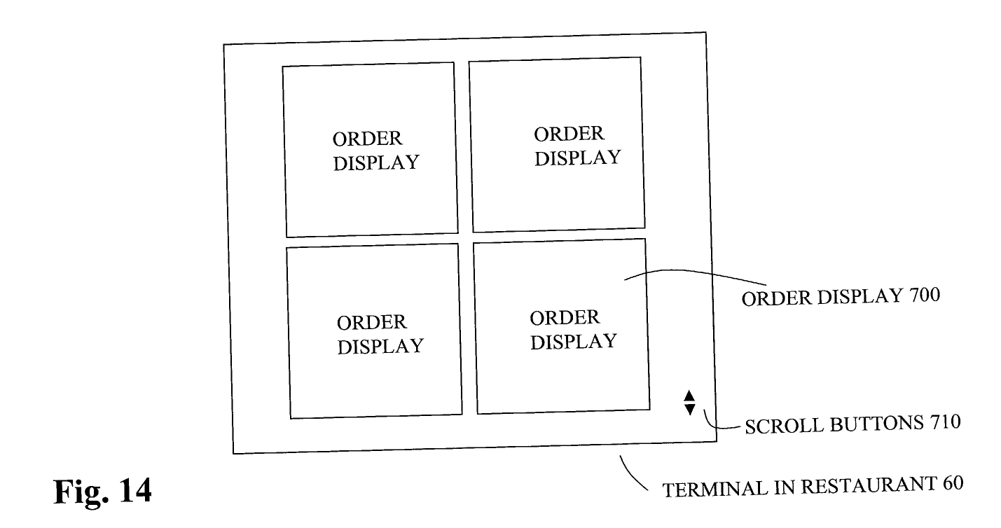

FIG. 14 is a schematic illustration of a plurality of orders being displayed as order displays 700 on a terminal in restaurant 60 according to one embodiment. The terminal in restaurant comprises scroll buttons 710 to enable employees in the restaurant to view all order displays in the event that they cannot all fit on the terminal in restaurant at the same time.

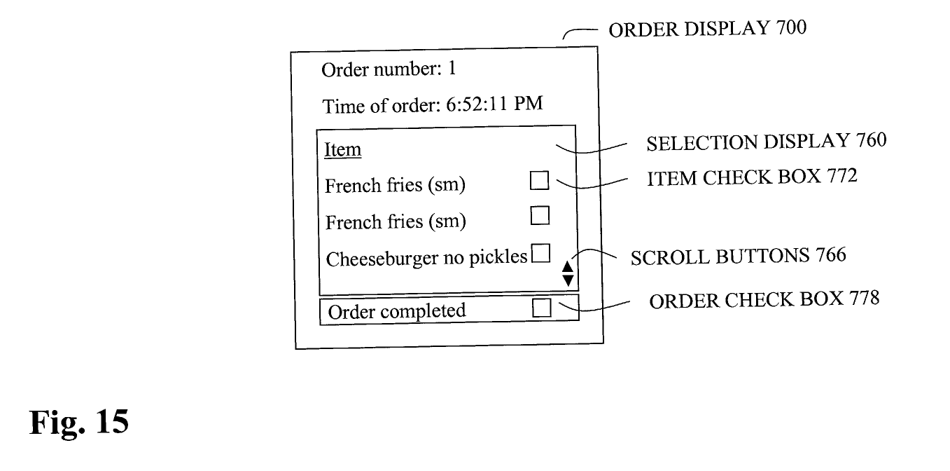

FIG. 15 is a more detailed schematic view of an individual order display 700 on the terminal in restaurant, according to one embodiment. It comprises a selection display 760; scroll buttons 766 for viewing the entire list of selections in the event that it is too long to be displayed in its entirety; item check boxes 772 for the employees, using a computer mouse, to mark items as completed as fulfillment of the order progresses; and an order check box 778 for the employees, using a computer mouse, to mark when fulfillment of the entire order is completed.

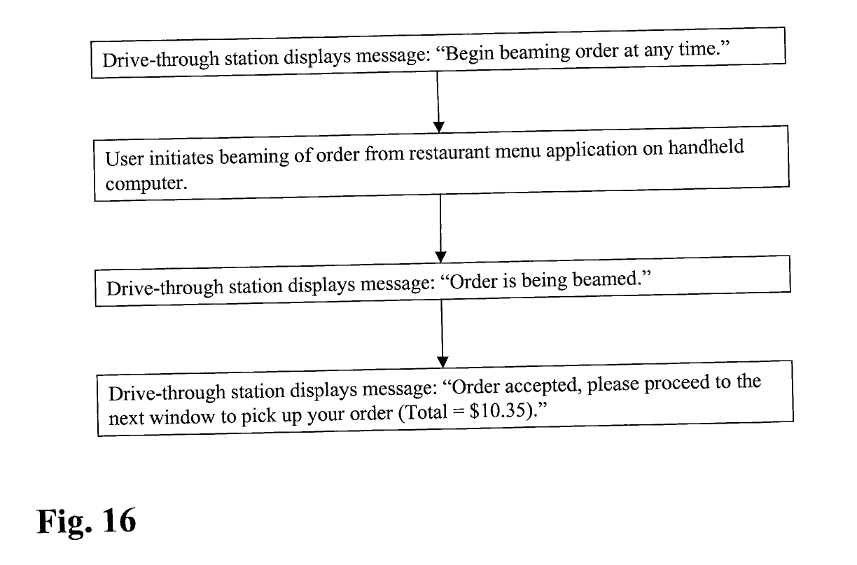

In one embodiment, the user will interact with the drive-through station as outlined in FIG. 16. When the drive-through station is in the ready state, it displays message: “Begin beaming order at any time.” The user initiates beaming of an order from the restaurant menu application on a handheld computer. The drive-through station, upon accepting initiation of beaming, displays a message: “Order is being beamed.” When the beaming process is completed, the drive-through station displays message: “Order accepted, please proceed to the next window to pick up your order (Total=$10.35).”

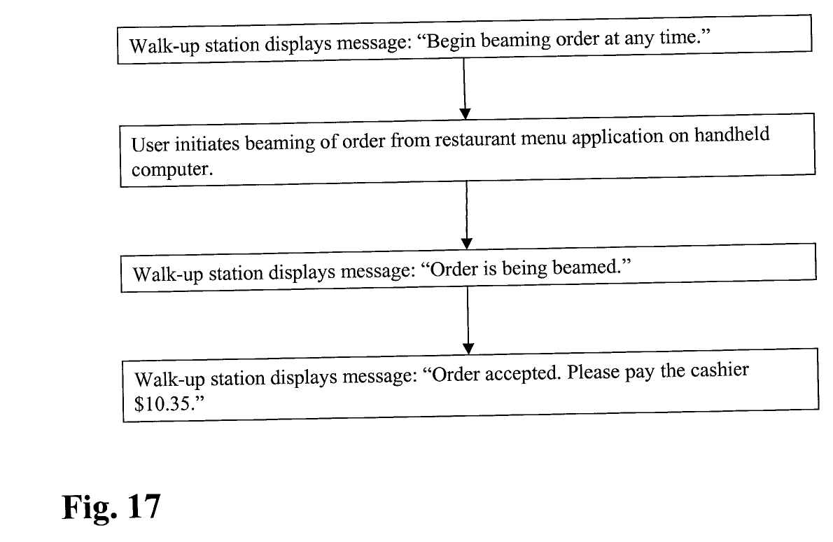

In one embodiment, the user will interact with the walk-up station as outlined in FIG. 17. When the walk-up station is in the ready state, it displays message: “Begin beaming order at any time.” The user initiates beaming of an order from the restaurant menu application on a handheld computer. The walk-up station, upon accepting initiation of beaming, displays a message: “Order is being beamed.” When the beaming process is completed, the walk-up station displays message: “Order accepted. Please pay the cashier $10.35.”

Payment information optionally may be transmitted with, before, or after an order transmission. Payment information refers to transmission of credit card information, prepaid credit, debit card information, or similar means of charging the customer for the purchase without necessitating the physical exchange of cash or coins during the transaction.

The invention will now be described by the following non-limiting examples.

### EXAMPLE 1

In her home, a customer can download from a fast food restaurant's web site the menu for the restaurant, in the form of a computer program (menu application) designed to run on the Palm operating system. She then can install the menu application on a Palm Vx handheld computer. The customer, still in her home, using her Palm Vx, can select the items and quantities she wishes to order when she will later go to a drive-through at a local franchise of the fast food restaurant. She can select the items by placing a check in appropriate boxes, and indicate the quantity for each item selected. She also can record any special requests, such as “no lettuce” in a comment field for each item. She can then save the selections in a file on the Palm Vx for later transmission to the drive-through station at the restaurant using the Palm Vx's IrDA compliant infrared communication port. The customer can then get in her car, and drive to the local franchise of the fast food restaurant, where she can drive to the drive-through ordering lane. When she approaches the ordering station (drive-through station), she can stop the car and open the window so that her Palm Vx can communicate with the drive-through station via infrared transmission. She can then select “Beam selection file” from a list of commands on the Palm Vx. A video screen on the drive-through station can then display a message: “Order accepted, please proceed to the next window to pick up your order (Total=$10.35).” The order can then be transmitted to a video monitor in the restaurant, where it can be fulfilled by restaurant workers. On the drive-through station there can be a small sign that reads: “Please press the ‘update’ button on this station to have copy of the latest version of the menu program beamed to your handheld computer.” This customer may not choose to update during this visit, since she just downloaded the program for the company's web site earlier in the day. The customer can then drive to the next window of the drive-through lane, pay for the order, and receive the items.

### EXAMPLE 2

At work, a customer can offer to pick up lunch at a nearby restaurant X for himself and a group of his coworkers. Prior to leaving, he can open the menu application on his Compaq iPAQ H3650 Pocket PC (handheld computer), select the menu for restaurant X, and record the selections for himself and several of his coworkers, and save the file on the handheld computer. He can then put the handheld computer in his pocket and walk or drive to restaurant X. After a brief wait in line, when he gets to the cash register where orders are submitted, he can take the handheld computer out of his pocket and beam the order to a walk-up station adjacent to the cash register. The cash register attendant may ask a follow-up question, such as: “Thank you for your order sir, will there be anything else?” After follow-up items are ordered, if any, the attendant can press a button and the order can be displayed on a screen in the kitchen, where the order can be fulfilled. The customer can then pay for the order, then receive the food a couple of minutes later, then return to the office and distribute it to those coworkers who placed orders.

Although the present invention has been described in terms of specific exemplary embodiments, it will be appreciated that various modifications and alterations might be made by those skilled in the art without departing from the spirit and scope of the invention as set forth in the following claims.

I claim:

1. A computer-readable storage medium stored within a transportable computer, said storage medium containing computer executable code for instructing a computer to operate as follows:
(a) displaying to a user a menu listing a plurality of items available for ordering from an item provider;
(b) in response to user input of a selection of an item to order, receiving said selection from said user;
(c) storing said selection in an order file in a memory storage device on said transportable computer;
(d) optionally repeating steps (b) and (c) for storing additional items in said order file; and
(e) in response to a user instruction to transmit said order file, remotely transmitting said order file to a receiving terminal at a location of said item provider without physical connection between said transportable computer and said receiving terminal.

2. The computer-readable storage medium of claim 1, said remotely transmitting instruction further comprising remotely transmitting said order file to a receiving terminal without telephony or satellite communication between said transportable computer and said receiving terminal.

3. The computer-readable storage medium of claim 1, said storage medium further comprising computer executable code for instructing a computer to display to said user a listing of a plurality of item providers, and displaying said menu in response to receiving user input of a selection of a single item provider from said plurality of item providers.

4. The computer-readable storage medium of claim 3, wherein said menu comprises a listing of substantially all items available for ordering from said single item provider.

5. The computer-readable storage medium of claim 1, wherein said menu comprises a listing of substantially all items available for ordering from said item provider.

6. The computer-readable storage medium of claim 1, said storage medium further comprising computer executable code for instructing said computer to receive a user instruction to open a previously saved order file from said memory storage device, to optionally repeat steps (b) through (c) for storing additional items in said order file and editing previously stored items in said order file, and to store a revised order file comprising at least said additional items and said edited items in said memory storage device.

7. The computer-readable storage medium of claim 1, wherein said instruction to remotely transmit said order file to a receiving terminal comprises instructing said computer to remotely transmit said order file via infrared transmission.

8. The computer-readable storage medium of claim 7, wherein said order file is formatted for reception by an IrDA compliant infrared transceiver.

9. The computer-readable storage medium of claim 1, wherein said instruction to remotely transmit said order file to a receiving terminal comprises instructing said computer to remotely transmit said order file via radio frequency transmission.

10. The computer-readable storage medium of claim 1, said storage medium further comprising computer executable code for instructing said computer to automatically receive a menu update instruction after transmitting an order file to a receiving terminal, and to modify said menu listing with said menu update instruction to create and store in said computer-readable storage medium a current menu listing.

11. The computer-readable storage medium of claim 1, said storage medium further comprising computer executable code for instructing said computer to calculate a total price of items in said order file, and display said total price to said user.

12. The computer-readable storage medium of claim 1, wherein said item provider comprises a restaurant.

13. A computer-readable storage medium at a location of an item provider and in communication with a receiving terminal at said location, said storage medium containing computer executable code for instructing a computer to operate as follows:
(a) in response to a customer transmission to said receiving terminal of an order file stored on a transportable computer, said order file comprising an identification of a plurality of items to be ordered, receiving said order file from said transportable computer without physical connection between said transportable computer and said receiving terminal; and
(b) transmitting order information relating to said order file from said receiving terminal to an order processing terminal within said location, said order processing terminal having a human readable display configured to display a human readable list of said order information.

14. The computer-readable storage medium of claim 13, said receiving instruction further comprising receiving said order file from said transportable computer without telephony or satellite communication between said transportable computer and said receiving terminal.

15. The computer-readable storage medium of claim 13, said storage medium further comprising computer executable code for instructing said computer to operate as follows:
(c) displaying a message to said customer indicating that said order has been accepted.

16. The computer-readable storage medium of claim 13, wherein said receiving terminal comprises a remote transmission receiver positioned adjacent to a customer drive-through lane at said location.

17. The computer-readable storage medium of claim 16, wherein said remote transmission receiver further comprises an IrDA compliant infrared transceiver.

18. The computer-readable storage medium of claim 16, wherein said remote transmission receiver further comprises a radio frequency transceiver.

19. The computer-readable storage medium of claim 13, wherein said receiving terminal comprises a remote transmission receiver positioned at a customer service counter at said location.

20. The computer-readable storage medium of claim 19, wherein said remote transmission receiver further comprises an IrDA compliant infrared transceiver.

21. The computer-readable storage medium of claim 19, wherein said remote transmission receiver further comprises a radio frequency transceiver.

22. The computer-readable storage medium of claim 13, wherein said receiving terminal comprises a remote transmission receiver positioned at a personal customer dining location at said item provider location.

23. The computer-readable storage medium of claim 22, wherein said remote transmission receiver further comprises an IrDA compliant infrared transceiver.

24. The computer-readable storage medium of claim 22, wherein said remote transmission receiver further comprises a radio frequency transceiver.

25. The computer-readable storage medium of claim 13, said storage medium further comprising computer executable code for instructing said computer to calculate a total price of said list of items in said order file, and display said total price to said customer.

26. The computer-readable storage medium of claim 13, said storage medium further comprising computer executable code for instructing a computer to automatically transmit a menu update instruction to said transportable computer after receiving an order file from said transportable computer.

27. The computer-readable storage medium of claim 13, wherein said item provider comprises a restaurant.

28. A system for implementing a remote ordering system at a location of an item provider, comprising:
a receiving terminal comprising a remote transmission receiver configured to receive a transmission from a remote transportable computer placed in proximity to said remote transmission receiver, wherein said transmission comprises an order file including a listing of one or more items to be remotely ordered by a user; and
an order processing terminal in communication with said receiving terminal and configured to receive order information relating to said order file from said receiving terminal, said order processing terminal further comprising a human readable display configured to display a human readable list of said order information.

29. The system for implementing a remote ordering system of claim 28, wherein said remote transmission receiver is positioned adjacent to a customer drive-through lane at said location.

30. The system for implementing a remote ordering system of claim 29, said remote transmission receiver further comprising an IrDA compliant infrared transceiver.

31. The system for implementing a remote ordering system of claim 29, said remote transmission receiver further comprising a radio frequency transceiver.

32. The system for implementing a remote ordering system of claim 28, wherein said remote transmission receiver is positioned at a customer service counter at said location.

33. The system for implementing a remote ordering system of claim 32, said remote transmission receiver further comprising an IrDA compliant infrared transceiver.

34. The system for implementing a remote ordering system of claim 32, said remote transmission receiver further comprising a radio frequency transceiver.

35. The system for implementing a remote ordering system of claim 28, wherein said remote transmission receiver is positioned at a personal customer dining location at said item provider location.

36. The system for implementing a remote ordering system of claim 35, said remote transmission receiver further comprising an IrDA compliant infrared transceiver.

37. The system for implementing a remote ordering system of claim 35, said remote transmission receiver further comprising a radio frequency transceiver.

38. The system for implementing a remote ordering system of claim 28, wherein said item provider comprises a restaurant.

39. A method for remotely receiving an order at a restaurant comprising the following steps:
(a) providing a remote transmission receiver positioned in proximity to a customer ordering location at said restaurant;
(b) in response to a remote customer transmission to said remote transmission receiver of an order file stored on a transportable computer, said order file comprising an identification of a plurality of items to be ordered, receiving said order file from said transportable computer without physical connection between said transportable computer and said receiving terminal; and
(c) transmitting order information relating to said order file from said receiving terminal to an order processing terminal within said restaurant, said order processing terminal having a human readable display configured to display a human readable list of said order information.

40. The method for remotely receiving an order at a restaurant of claim 39, said receiving step further comprising receiving said order file from said transportable computer without telephony or satellite communication between said transportable computer and said receiving terminal.

41. The method for remotely receiving an order at a restaurant of claim 39, further comprising the step of (d) notifying said customer that said order has been accepted.

42. The method for remotely receiving an order at a restaurant of claim 39, wherein said providing step further comprises providing said remote transmission receiver such that said remote transmission receiver is positioned adjacent to a customer drive-through lane at said restaurant.

43. The method for remotely receiving an order at a restaurant of claim 42, wherein said receiving step further comprises receiving an infrared transmission including said order file.

44. The method for remotely receiving an order at a restaurant of claim 42, wherein said receiving step further comprises receiving a radio frequency transmission including said order file.

45. The method for remotely receiving an order at a restaurant of claim 39, wherein said providing step further comprises providing said remote transmission receiver such that said remote transmission receiver is positioned at a customer service counter at said restaurant.

46. The method for remotely receiving an order at a restaurant of claim 45, wherein said receiving step further comprises receiving an infrared transmission including said order file.

47. The method for remotely receiving an order at a restaurant of claim 45, wherein said receiving step further comprises receiving a radio frequency transmission including said order file.

48. The method for remotely receiving an order at a restaurant of claim 39, wherein said providing step further comprises providing said remote transmission receiver such that said remote transmission receiver is positioned at a personal customer dining location at said restaurant.

49. The method for remotely receiving an order at a restaurant of claim 48, wherein said receiving step further comprises receiving an infrared transmission including said order file.

50. The method for remotely receiving an order at a restaurant of claim 48, wherein said receiving step further comprises receiving a radio frequency transmission including said order file.

51. The method for remotely receiving an order at a restaurant of claim 39, further comprising the step of (d) automatically transmitting a menu update instruction to said transportable computer after receiving said order file from said transportable computer.
